(19) United States
(12) Patent Application Publication
(10) Pub. No.: US 2017/0279324 A1
(43) Pub. Date: Sep. 28, 2017

(54) METHOD FOR PRODUCING A FORM-WOUND COIL FOR A LAMINATED STATOR CORE

(71) Applicant: WOBBEN PROPERTIES GMBH, Aurich (DE)

(72) Inventor: Jochen RÖER, Ganderkesee (DE)

(21) Appl. No.: 15/503,956

(22) PCT Filed: Aug. 6, 2015
(86) PCT No.: PCT/EP2015/068197

§ 371 Date: Feb. 14, 2017

(30) Foreign Application Priority Data
Aug. 14, 2014 (DE) 10 2014 216 210.6

(51) Int. Cl. H02K 3/12; H02K 7/18; H02K 3/28; H02K 15/04; H02K 15/085

(52) U.S. Cl. CPC H02K 3/12; H02K 15/0414; H02K 15/085; H02K 3/28; H02K 7/1838; F03D 9/25

(57) ABSTRACT

A method for producing a form-wound coil for fitting into a laminated stator core of a synchronous generator of a gearless wind turbine, comprising the steps of cutting out at least one first flat strip conductor from a metal sheet with a first slot-strip portion, for inserting into a first slot of the laminated core, cutting out at least one second flat strip conductor from a metal sheet with a second slot-strip portion, for inserting into a second slot of the laminated core, and angling away the first and/or second cut-out strip conductor in such a way as to create an angled-away winding head portion, for connecting the first and second slot-strip portions.

### BACKGROUND

Technical Field

The present disclosure relates to a method for producing a form-wound coil for fitting into a laminated stator core of a synchronous generator of a gearless wind turbine. The present disclosure also relates to such a form-wound coil and to a winding assembly with a number of form-wound coils. The present disclosure also relates to a synchronous generator with such form-wound coils or with such a winding assembly. The present disclosure also relates to a wind turbine.

Description of the Related Art

Gearless wind turbines have very slowly rotating generators. Slowly rotating synchronous generators, particularly ring generators, have proven to be advantageous for these. A ring generator is understood here as being a generator in which the magnetically active elements are arranged on an annular region around the axis of rotation of the generator.

Such a synchronous generator has a stator, which has a laminated core in which windings are accommodated in slots. During the operation of the generator, voltages, and consequently currents, are generated in these windings. Because such a synchronous generator for a gearless wind turbine is very slowly rotating, for example approximately in the range of 15 rpm, it has a very high number of stator slots and consequently stator poles. The number may for example lie in the range of 48, 96, 192 or even higher. The producing or winding of such stators may consequently be very complex.

A method for the winding of such stators, that is to say the winding of laminated stator cores, is described in U.S. Pat. No. 7,432,610. Copper windings for a 6-phase system, specifically two 3-phase systems, are wound there in a method that is complex, but has nevertheless become very favorably established. Two strands comprising many individual copper wires are provided for each of the phases, so that with this continuous winding that is described there a total of 12 winding strands have to be wound. The winding of such a laminated stator core, which may have a diameter of approximately five meters, may take a number of employees working well together several days to complete. The German Patent and Trademark Office has searched the following prior art in the priority application relating to the present application: US 2007/0170810 A1 and DE 102 15 937 A1.

### BRIEF SUMMARY

Proposed is a solution that simplifies the production of such a synchronous generator of a gearless wind turbine, and as far as possible also makes it less costly. It is intended at least to propose an alternative solution to the previously known solutions.

A method for producing a form-wound coil is proposed. Such a method for producing a form-wound coil produces a form-wound coil that is prepared for fitting into a laminated stator core of a synchronous generator of a gearless wind turbine.

In order to build in an electrically equivalent manner the continuous bundles of wires of the generator with inserted individual coils that is described in U.S. Pat. No. 7,432,610, specifically with individual coils like the proposed form-wound coil, the individual coils must be connected to one another in order that a series connection of the individual coils is created.

For the case of a 6-phase system, such a form-wound coil encloses six stator poles or stator teeth. It then therefore lies in a first slot and a seventh slot.

The production of this form-wound coil thus takes place in such a way that firstly at least one flat strip conductor is cut out from a metal sheet. Correspondingly, this strip conductor is just as flat as the metal sheet from which it has been cut out. The strip conductor cut out in this way is then shaped for example as a large U or the like, or as part, in particular half, of a U. In the case of this U-shaped configuration, the two legs may be very long and lie very close together.

In the next step, an angling away of the cut-out strip conductors then takes place in such a way as to create a first slot-strip portion, for inserting into a first slot of the laminated core, a second slot-strip portion, for inserting into a second slot of the laminated core, and at least one winding head portion, connecting the two slot-strip portions and to be arranged outside the slots. The angling away takes place in such a way that the two slot-strip portions are essentially displaced parallel to one another. Therefore, the angling away may for example have the effect that the one slot-strip portion is raised in relation to the other slot-strip portion. Tilting the two slot-strip portions, specifically angling away the winding head portion appropriately, creates a configuration in which the result is for these slot-strip portions to be arranged at a distance one above the other with respect to the plane of the starting sheet from which the strip conductor was cut out. These two slot-strip portions in this case remain in their arrangement plane-parallel to one another, arranged one above the other. In the angling-away process, there may be interim situations in which the two slot-strip portions are briefly not plane-parallel to one another, but these two slot-strip portions substantially, and particularly after complete angling away, have the said plane-parallelism in relation to one another.

In the case of a sheet-metal form-wound coil with two turns, preferably a total of four lasered and angled metal sheets are welded into a coil, which is then inserted into the laminated core.

These two slot-strip portions can then be fitted into the corresponding slot of the laminated core; in the case of the 6-phase system, therefore, into a first slot and a seventh slot.

These two slot-strip portions are not exactly plane-parallel, because the laminated stator core has a circular form and the form-wound coil, and consequently the two slot-strip portions, are fitted in a radial direction, but they are referred to here as plane-parallel to describe their basic arrangement in relation to one another. The angular deviation between the slots concerned is taken into account in the production of the sheet-metal form-wound coil.

At least the form-wound coil produced in this way corresponds to a one-piece construction that has been cut out from the metal sheet and brought into its shape by angling away, and thereby substantially represents a rigid component. To produce an overall winding, many such form-wound coils are thus produced and connected to one another. In this case, of course, only the form-wound coils of the respective phase are connected to one another. The next form-wound coil of this phase would therefore be inserted into the 13th slot and 19th slot and the first slot-strip portion of one of these two form-wound coils would be electrically connected to the second slot-strip portion of the second of these two form-wound coils.

In the production process of the overall stator, however, firstly a form-wound coil of a first phase would be fitted into a first slot and a seventh slot and then a form-wound coil of a next phase would be fitted into the second slot and the eighth slot. In this way, a total of six form-wound coils would be used for the said 6-phase system, and would then correspondingly be seated with their slot-strip portions in the first slot to the twelfth slot. The procedure can then be continued again with a form-wound coil of the first phase, which is correspondingly fitted into the 13th slot and the 19th slot.

The cutting out and angling away preferably take place in such a way that, with this successive fitting of one form-wound coil next to the other, the winding head portions are also arranged next to one another.

One possible way of ensuring such an arrangement next to one another, while the form-wound coils can also be successively fitted into the slots one after the other in the way described above, is by appropriate shaping. One possible way of shaping is by part of the winding head portion being offset by a width of the first or second slot-strip portion. In particular, both the first slot-strip portion and the second slot-strip portion are of the same width here, and this offset portion of the winding head portion is also likewise as wide. In graphical terms, this would produce a setup in which the first form-wound coil in the fitted state is fitted with its first slot-strip portion in the first slot. From the slot, it then goes over into the offset region of the winding head portion, which consequently rises up outside the laminated stator core, in the case of an internal rotor, towards the outer side of the generator to be produced. This portion therefore protrudes beyond the slot openings over the full width of the slot-strip portion or over the full height of the slot. This protruding portion then goes over into a non-offset portion, which goes over into the second slot-strip portion, which is then led into the seventh slot.

When fitting a second form-wound coil with its first slot-strip portion into the second slot, here too this offset portion of the winding head portion protrudes beyond the slot opening of the stator. Consequently, this portion also protrudes beyond the non-offset portion of the winding head portion of the first form-wound coil. This allows the creation here of the necessary crossing region, which is necessary to lead this second form-wound coil from the second slot to the eighth slot, and consequently cross the portion of the first form-wound coil that runs to the seventh slot.

In this way, the form-wound coils can be successively inserted in the way already described above. Being produced from the metal sheet means that it is consequently also possible for these winding head portions to be of a very flat configuration, so that this successive interleaved insertion is possible. According to one embodiment, it is proposed to produce a form-wound coil from a piece of metal sheet. This also allows the creation of a stable formation, which can also be mechanically stable and load-bearing. This also allows many identical form-wound coils to be produced with only very small tolerances in relation to one another. This one-piece form particularly allows the transition between the slot portions over the winding head portion to be made very stable.

Nevertheless, the form-wound coil may alternatively be produced from at least two assembled sheet-metal portions, in that in particular one sheet-metal portion comprises a first slot-strip portion and the winding head portion and the second sheet-metal portion comprises a second slot-strip portion. These individual sheet-metal portions can then be assembled, for example after the angling away. This may take place for example by screwing or welding. In this case, increased effort for carrying out the assembly and any stability problems that may be brought about by the assembly would be accepted in return for simplifying the production of the individual parts.

The slot-strip portions preferably have in each case a strip surface. This strip surface has formed part of a surface of the metal sheet during or before the cutting out from the metal sheet. The form-wound coil is thus formed in such a way that it is prepared for fitting into the laminated core, specifically into the slots, in a direction parallel to this strip surface. The surface respectably lies against one side of the slot concerned or, at least in the state in which it is fitted in the slot, runs parallel to the side of the slot.

According to one variant, the following are proposed as steps for producing a form-wound coil:

cutting out at least one first flat strip conductor from a metal sheet with a first slot-strip portion, for inserting into a first slot of the laminated core,

cutting out at least one second flat strip conductor from a metal sheet with a second slot-strip portion, for inserting into a second slot of the laminated core,

angling away the first and/or second cut-out strip conductor in such a way as to create an angled-away winding head portion, for connecting the first and second slot-strip portions.

It is accordingly proposed to cut out each strip conductor that is to be fitted into a slot separately from the metal sheet. At least two such cut-out strip conductors are therefore required for a form-wound coil. Thus, these strip conductors are angled away in such a way as to create an angled-away winding head portion, by way of which the slot-strip portions can be connected. A form-wound coil is then assembled from at least two such cut-out and partially angled-away slot-strip portions. Four such slot-strip portions can preferably be assembled, so that the form-wound coil is formed not only in a U-shaped manner, but also in a loop-shaped manner, so that therefore two slot-strip portions respectively lie in a slot. Correspondingly, the slot-strip portions connected to one another by way of the winding head portion are arranged plane-parallel to one another, specifically as intended in different slots and consequently in different planes. The slot-strip portions connected to one another in this way, that is to say for example two or four, form the form-wound coil to be produced, which is correspondingly rigidly formed.

Each slot-strip portion preferably has a winding head subportion. Two slot-strip portions are respectively connected in the region of their winding head subportions; in particular, they are welded to one another. This takes place in such a way that the two winding head subportions form the winding head portion. In particular, the slot-strip portions are formed with their winding head subportions in such a way that the two winding head subportions are substantially in contact in a region in which they are welded to one another before the slot-strip portions are fitted as intended into two corresponding slots. Each slot-strip portion consequently has a slot leg, which respectively runs in a slot, and at least one winding head subportion, which runs outside the slot.

It is preferably first welded and then inserted.

The cutting out and angling away therefore creates sub-elements, which are already adapted in their shape for use in the stator in such a way that, together with many other slot-strip portions that are likewise respectively fitted in their slots, they can form a winding of the stator.

Slot-strip portions are hereby welded to one another and inserted as a finished coil into 2 slots in each case.

According to one embodiment, it is proposed that the metal sheet that forms the starting material is produced from aluminum. Consequently, when such an aluminum sheet is used, this creates a form-wound coil, and consequently as a result a winding of the stator, that is produced from aluminum.

Aluminum is not as electrically conductive as copper, so that copper is usually preferred over aluminum. Furthermore, known machines are usually designed for the use of copper because its temperature development during the rated operation of the machine is known. This knowledge of the temperature development is based on the known electrical properties, in particular the current to be expected and the heat developing as a result, in particular in the copper windings. It must be possible for this heat to be removed through the structural form of the generator. If aluminum is used, more intensive heating must be initially expected on account of the higher resistivity, which argues against the use of aluminum. In particular, higher temperatures that the machine is not designed to remove would have to be expected.

It has been recognized here, however, that a very high filling factor for the slots can be achieved by using the metal sheets of aluminum. This filling factor is much greater than when using strands of round wires, such as copper strands of round copper wires, and this actually allows a quite similar electrical property to be ultimately obtained again.

At the same time, the weight of such a generator with aluminum windings is much less than when copper is used, because, although copper can achieve the same electrical conductivity with a smaller cross section, that is to say a smaller volume, at the same time copper has a significantly higher specific density. As a result of the favorable filling factor brought about by the provision of the proposed flat strip conductors, a similar overall ohmic resistance of the winding as when using round copper wires can be achieved in first approximation with these slot-strip portions of aluminum in slots of approximately the same size.

The cutting out of the strip conductors or strip-conductor portions is preferably performed by means of waterjet cutting or lasering. This allows automation to be achieved, and to this extent this method of cutting out is very well suited for the strip-conductor portions to be produced, because very many of them have to be produced with the same configuration. In an example of a stator with 2 turns and 432 slots, 216 individual coils with in each case 4 individual metal sheets are required for example.

According to a further embodiment, it is proposed that the slot-strip portions, at least their slot legs, are separated into a number of parallel conducting portions. Correspondingly, a number of conducting portions lie next to one another, with respect to the metal sheet from which they are cut out, that is to say with respect to this flat alignment. When they are being fitted into the respective slots, however, these conducting portions lie one above the other, that is to say that they lie one above the other from a slot base to a slot opening. They are consequently stacked in a radial direction and can consequently prevent transverse currents in a radial direction, which may occur due to skin effects during the operation of the generator.

This division into a number of parallel conducting portions may take place by water cutting or lasering and is preferably carried out before the angling away. An advantageous embodiment also proposes that interspaces between the parallel conducting portions of the divided slot-strip portions are provided with an electrical insulating material.

After separating, in particular by lasering or water cutting, it may be that the individual strips are not very stable. Here it is proposed firstly to provide a casting compound that should be as thermally conductive as possible between the parallel conducting portions before the angling, in order that the part is not damaged, or is damaged as little as possible, during the subsequent angling process. Among the advantages of the sheet-metal coil is that of creating a formation of the winding heads that is as geometrically exact and identical as possible, with a large surface and consequently good cooling properties. Such a casting compound is conducive to this.

A first parallel conducting portion preferably reaches from a first slot-strip portion to a second slot-strip portion, such a conducting portion changing its relative position in the respective slot, specifically in such a way that it is led from one slot out of the lower region or base region to the other slot to an upper region, that is to say towards the region of the opening. In other words, such a parallel conducting portion is appropriately diverted in the winding head region that specifically connects these two slot-strip portions. This may also be advantageous with respect to making allowance for skin effects.

The parallel conducting portions of a slot-strip portion preferably have different cross sections. Partially different conductances are consequently created there in different positions of the slot concerned. This also makes allowance for the fact that currents of different levels may occur. Providing the form-wound coils in this way, by cutting out and angling away, allows such individual conducting cross sections for individual conducting portions to be provided in a way that is easy and also reliable and reproducible.

Within a form-wound coil, the individual strips must be drawn through as electrically separate individual strips, including in the region of the winding heads. During the later connecting of the inserted individual coils by way of connecting elements, these connecting elements can be configured between the form-wound coils without individual strips.

Also proposed is a form-wound coil that has been produced by a method according to one of the foregoing embodiments.

Also proposed is a winding assembly that has a number of form-wound coils according to at least one embodiment described above.

The winding assembly preferably has a number of form-wound coils and in each case a connecting portion between two form-wound coils, the connecting portion being produced by cutting out a flat connecting region from a metal sheet, in particular also from an aluminum sheet, and angling away the flat conducting region in such a way that it can be attached to two slot-strip portions for connecting the same. In this case, it is changed by the angling away in such a way that it can reach over a number of slots between the two form-wound coils. In particular, it will connect a slot-strip portion of the first form-wound coil to a slot-strip portion of the second form-wound coil. It thereby reaches for example over the 8th slot to the 12th slot if the one slot-strip portion is arranged in the 7th slot and the other slot portion of the other form-wound coil is arranged in the 13th slot, as would be the case with a 6-phase system.

The connecting portion preferably corresponds in its structure to the winding head portion.

A winding assembly, which may also be referred to simply as a winding or overall winding of the stator, consequently comprises all of the coils necessary for it. In the case of a 6-phase system, this winding assembly therefore comprises all six phases. This applies generally. When the connecting portion preferably proposed above is used, a wound stator therefore takes the form that winding head portions of the form-wound coils protrude on both sides of the laminated stator core. Furthermore, the connecting portions are present, specifically in each case one between two form-wound coils. Particularly in the overall view of the stator wound in this way, these winding head portions are scarcely distinguishable from the connecting portions. The main distinction may arise as a result of the symmetry of their occurrence in the overall wound unit.

Also proposed is a stator of a generator of a gearless wind turbine that has a stator with a laminated stator core. Fitted in the laminated stator core is a winding assembly according to one of the embodiments described above. This can also be described by saying that the laminated stator core is wound with a winding assembly according to one of the foregoing embodiments.

In particular, the slots of the laminated stator core are rectangular in their cross section, in particular without restricting the opening facing as intended towards the air gap. This proposal allows the plate-shaped slot-strip portions to be pushed in easily in a radial direction. It has been found that the widening of the corresponding slots has no appreciable effect on the behavior, in particular magnetic behavior, of the generator. Particularly, a feared high harmonic component has not materialized.

It has consequently been recognized that this rectangular cross-sectional form can be readily provided and, as a result, it is possible to achieve the effect that such a stator, and consequently a corresponding generator, can be easily produced. This also makes it possible to implement a higher degree of automation when fitting the components.

Also proposed is a synchronous generator of a gearless wind turbine that has a stator according to an embodiment described above.

Also proposed is a wind turbine with a synchronous generator, using a synchronous generator according to a foregoing embodiment.

### BRIEF DESCRIPTION OF THE SEVERAL VIEWS OF THE DRAWINGS

The invention is explained in more detail below by way of example on the basis of exemplary embodiments with reference to the accompanying figures.

FIG. 1 shows a wind turbine in a perspective view.

FIG. 2 schematically shows a generator of a gearless wind turbine in a side view.

FIG. 3 schematically shows a stator of a generator of a gearless wind turbine in a side view.

FIG. 4 schematically shows a detail of a stator of a generator of a gearless wind turbine with two fitted form-wound coils.

FIGS. 5 and 6 respectively show a slot-strip portion of a first loop in a perspective view.

FIG. 7 shows the two slot-strip portions of FIGS. 5 and 6 in a state of being assembled into a first loop.

FIGS. 8 and 9 show a third slot-strip portion and a fourth slot-strip portion of a form-wound coil.

FIG. 10 shows the two slot-strip portions of FIGS. 8 and 9 in a state of being assembled into a second loop.

FIG. 11 shows a form-wound coil, assembled from the four slot-strip portions of FIGS. 5, 6, 8 and 9.

FIG. 12 shows two form-wound coils, respectively according to FIG. 11, connected to one another by way of a connecting portion.

### DETAILED DESCRIPTION

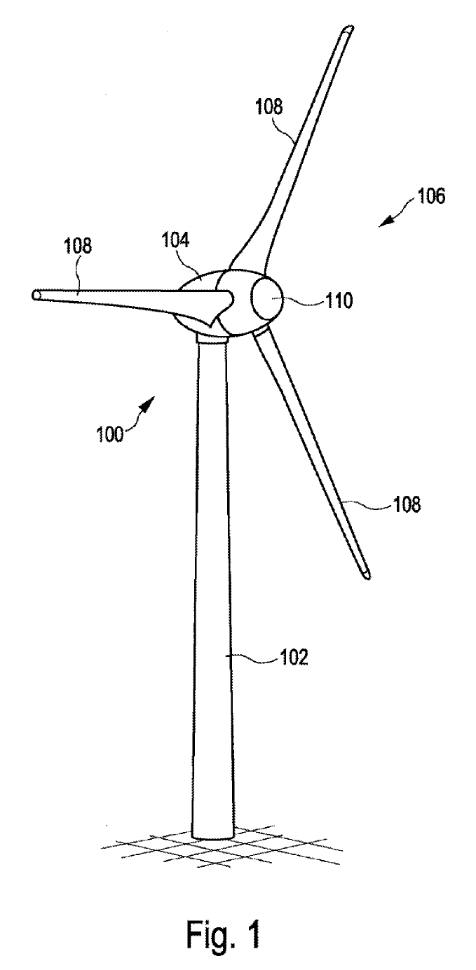

FIG. 1 shows a wind turbine 100 with a tower 102 and a nacelle 104. Arranged on the nacelle 104 is a rotor 106 with three rotor blades 108 and a spinner 110. During operation, the rotor 106 is set in a rotational movement by the wind and thereby drives a generator in the nacelle 104.

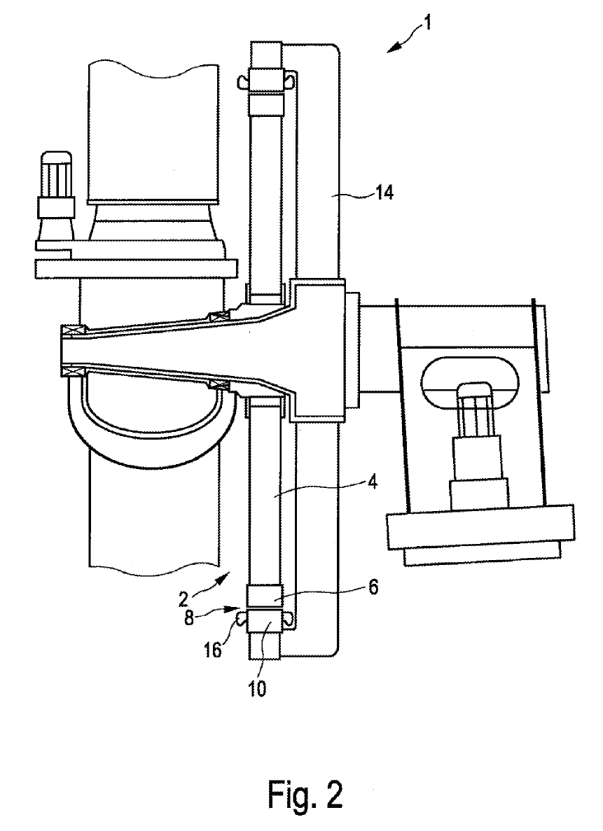

FIG. 2 schematically shows in a side view a generator 1 with a rotor 2 with a rotor carrier 4 and a rotor pole region 6, which, separated by an air gap 8, can rotate in the stator 10 of the generator 1. The stator 10 is held by a stator carrier 14, which, like the rotor carrier 4, is preferably of a star-shaped form. A winding head 16 is also indicated on both sides of the stator 10. To this extent, the region of the winding that respectively establishes a connection between individual slots is referred to as the winding head.

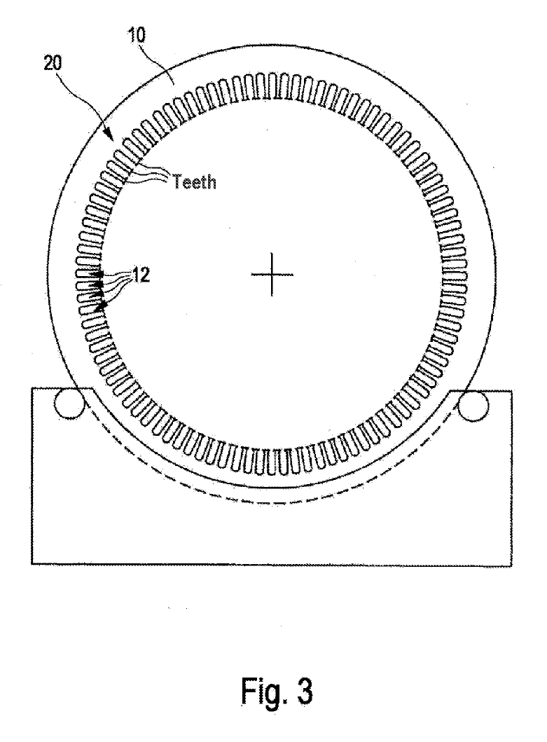

FIG. 3 shows an unwound stator 10 in a side view, which may also be referred to as an axial view. Unwound slots 12 are likewise schematically represented there. The slots 12 alternate with teeth 18 and, together with a base region 20, the teeth 18 are formed by stacking many individual metal sheets, specifically stacked to form a laminated stator core.

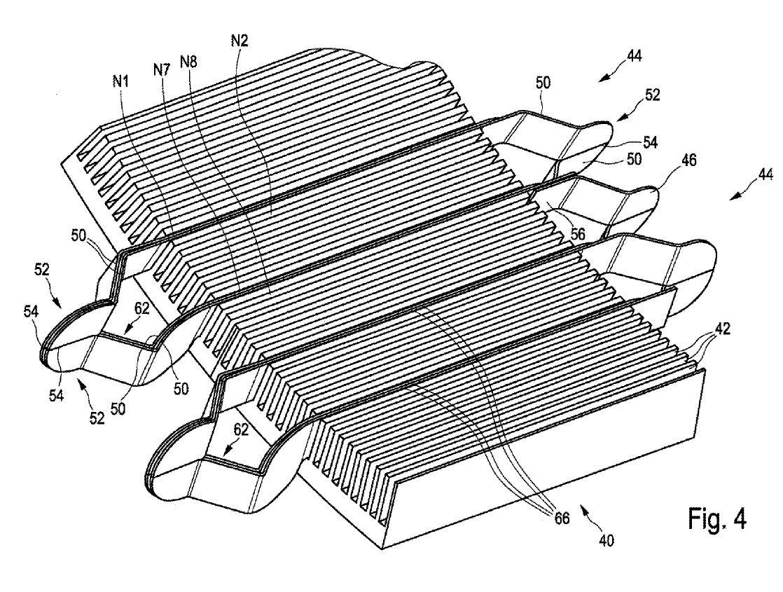

FIG. 4 then shows a laminated stator core 40 in a perspective detail, with a large number of slots or stator slots 42 of a substantially rectangular cross section. In some of these slots 42 there are fitted two form-wound coils 44, given by way of example, and these two form-wound coils 44 are connected by a connecting portion 46.

FIG. 4 is an illustrative representation and does not necessarily reflect the sequence in which the laminated stator core 40 is wound or loaded with components. The two form-wound coils 44 that are shown form part of the wound unit of one of six phases. The two form-wound coils 44 are respectively assembled from four slot-strip portions 48. Two slot-strip portions or a part thereof, specifically the slot legs 66, are respectively accommodated in one of the slots 44. For the sake of simplicity, the same reference sign, that is 48, is used here for the slot-strip portions, even though the slot-strip portions 48 differ in some details, as can already be seen in FIG. 4.

Each slot-strip portion 48 also has at least one winding head subportion 50, which are respectively arranged outside the slots 42. Two winding head subportions 50 are respectively assembled into a winding head portion 52. This assembly is achieved by welding at the weld seam 54.

It can be seen that the winding head portions 52 very strongly resemble the connecting portion 46. The two differences are essentially only that the connecting portion 46 is respectively fastened, specifically welded, at connecting legs 56 to a slot-strip portion. And, as a second difference, this ultimately also results in the connecting portion 46 not having a weld seam like the weld seam 54 of the winding head portions 52.

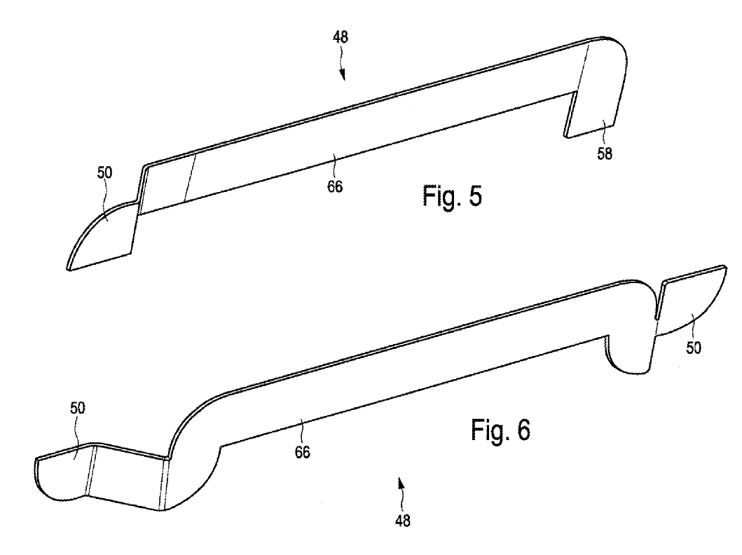

FIGS. 5 and 6 then respectively show a slot-strip portion 48. FIG. 5 has in this case a winding head subportion 50 and also a connection region 58. At the connection region 58, a connection to a connecting portion 46 can be established or, in the case of the last form-wound coil, it will be possible to provide a connection there for electrically connecting the generator.

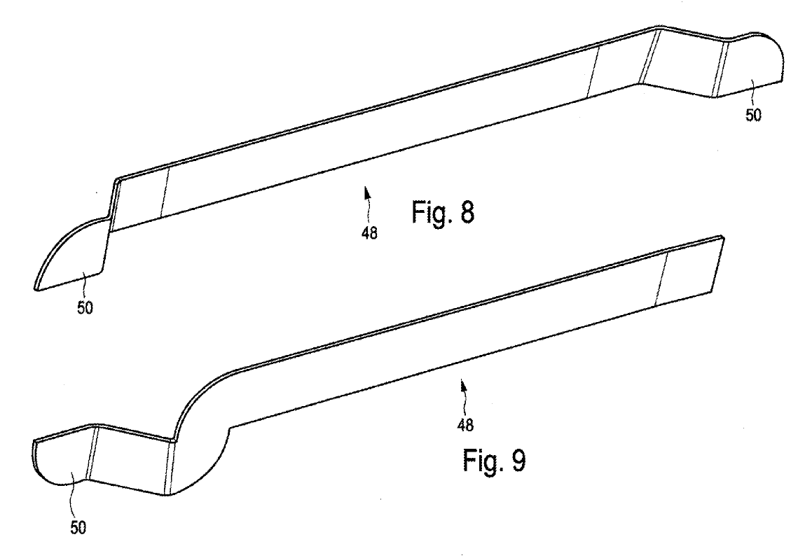

The slot-strip portion 48 of FIG. 6 has two winding head subportions 50, which can be respectively connected to a winding head subportion of a further slot-strip portion, specifically on the one hand to that of FIG. 5 and on the other hand to that of FIG. 8.

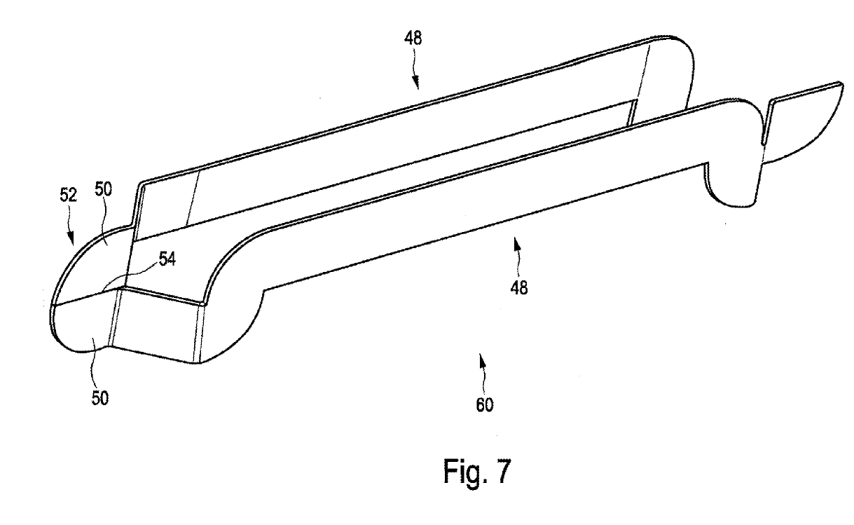

FIG. 7 then shows the two slot-strip portions 48 of FIGS. 5 and 6 assembled. For this purpose, they are welded in their two winding head subportions 50 at the weld seam 54. Correspondingly, the winding head portion 52 is also created there.

FIGS. 8 and 9 likewise show two slot-strip portions 48, and here the slot-strip portion 48 of FIG. 8 has two winding head subportions 50 and the slot-strip portion 48 of FIG. 9 has only one winding head subportion 50.

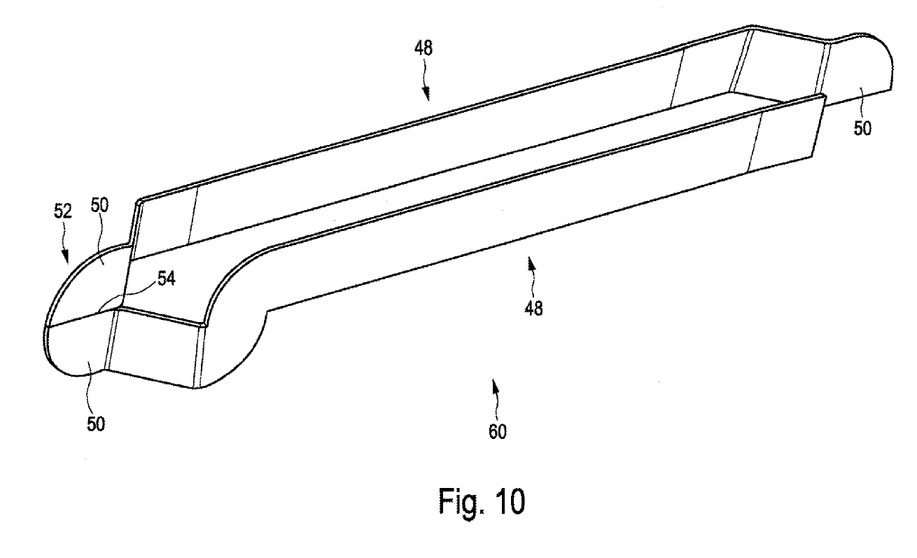

FIG. 10 shows the connection of these two slot-strip portions 48 of FIGS. 8 and 9. Here, too, the connection takes place at the weld seam 54, so as to create a stable overall part and also create the winding head portion 52.

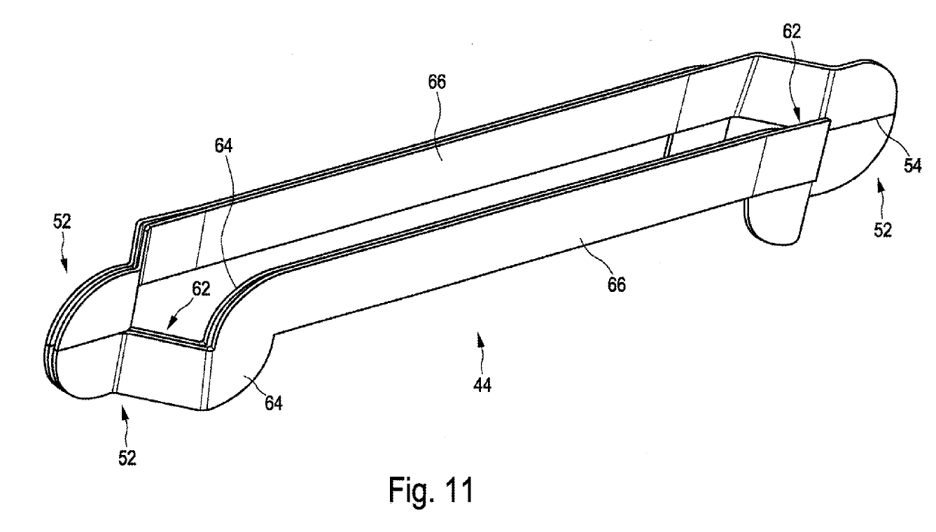

These two form-wound part-coils 60 of FIGS. 7 and 10 are then assembled into a form-wound coil 44 such as that shown in FIG. 11. For this purpose, the weld seam 54 that is represented on the right in FIG. 11 must have been made.

The form-wound coil 44 shows two lowered regions 62 in the region of its three winding head portions 52, specifically two in the left-hand region of FIG. 11 and one in the right-hand region of FIG. 11. This lowered region 62 can be seen very well on the left-hand side in FIG. 11 and can only be seen with difficulty in the side on the right because it is covered by part of a slot-strip portion. This lowered region 62 is achieved by a diverting portion 64. This diverting portion 64 diverts the slot leg 66 concerned of the slot-strip portion 48 concerned appropriately downwards. The part of the slot-strip portion that lies as a straight portion in the respective slot is referred to here, and not only in the case of the embodiment shown, as the slot leg 66. From here, the diverting portion 64 diverts the slot-strip portion downwards, essentially by a width of the slot leg 66.

The purpose can probably be seen best in FIG. 4. FIG. 4 shows two fitted form-wound coils 44, which both belong to the same phase. In the state of the stator 40 in which it has been completely fitted with components or wound, there are six times as many form-wound coils 44 in the same region. If, according to FIG. 4, the first form-wound coil 44 lies in the first slot N1 and the seventh slot N7, a form-wound coil 44 (not shown here) of a next phase would lie in the second slot N2 and the eighth slot N8. In order to realize this configuration, this form-wound coil 44 that is not shown must cross the form-wound coil 44 shown in the first slot N1 and the seventh slot N7 at the lowered region 62. This is made possible by this lowering of the lowered region 62.

It can be seen that consequently firstly all of the form-wound coils 44, that is to say not only those of the first phase but those of all the phases, are fitted, and then the form-wound coils of the respective phases are connected by the connecting portions 46.

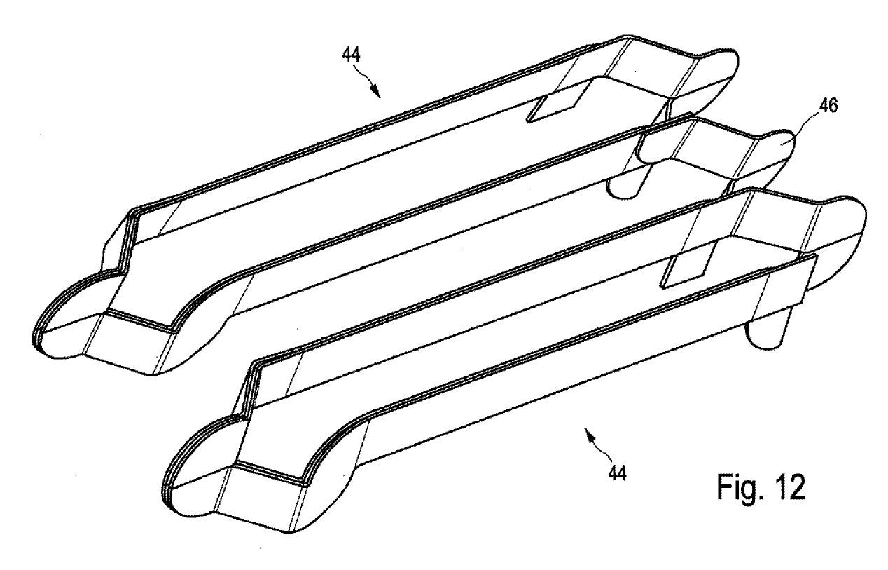

Incidentally, to provide a better overview in FIG. 12, the arrangement of the two form-wound coils 44 together with the connecting portion 46 is shown without the laminated stator core 40.

The form-wound coil represented in the figures, specifically a sheet-metal coil, has two turns. It therefore consists within a slot of two sheet-metal strips, for example each of 6 mm. A coil with, for example, five turns can also be realized by the technique described, in that five sheet-metal strips each of 3 mm lie in a slot.

It is to use sheet metal instead of wire and using methods that can be automated well, lasering, or waterjet cutting, angling and welding.

It has also been recognized that, with an existing slot geometry, the same electrical resistance as with round wires can be achieved with aluminum as a result of the improvement in the filling ratio. With sheet-metal coils of copper, a smaller overall construction could be obtained.

1. A method comprising:
producing a form-wound coil for fitting into a laminated stator core of a synchronous generator of a gearless wind turbine, wherein producing comprises:
cutting out at least one first flat strip conductor from a metal sheet with a first slot-strip portion configured to be inserted into a first slot of the laminated stator core,
cutting out at least one second flat strip conductor from a metal sheet with a second slot-strip portion, configured to be inserted into a second slot of the laminated stator core,
angling away at least one of the first and second cut-out strip conductors in such a way that creates an angled-away winding head portion and configured to couple the first and second slot-strip portions together.

2. The method according to claim 1, further comprising:
connecting the first and second slot-strip portions together by way of the winding head portion in such a way that the first and second slot-strip portions are arranged plane-parallel to one another in different planes.

3. The method according to claim 2, wherein:
each of the first and second slot-strip a winding head subportion and a slot leg, and
connecting the first and second slot-strip portions connecting at regions of winding head subportions in such a way that the winding head subportions form the winding head portion.

4. A method comprising:
producing a form-wound coil for fitting into a laminated stator core of a synchronous generator of a gearless wind turbine, comprising the steps of
cutting out a flat strip conductor from a metal sheet,
angling away the cut-out flat strip conductor in such a way as to create:
a first slot-strip portion configured to be inserted into a first slot of the laminated core,
a second slot-strip portion configured to be inserted into a second slot of the laminated core, and
at least one winding head portion configured to connect the slot-strip portions together and to be arranged outside the slots, and
fitting the form-wound coil into the laminated stator core by inserting the first slot-strip portion into the first slot of the laminated stator core and inserting the second slot-strip portion into the second slot of the laminated stator core, the first and second slot-strip portions being displaced parallel to one another by the angling away.

5. The method according to claim 4, wherein:
the first and second slot-strip portions each have a strip surface, that forms part of a surface of the metal sheet during the cutting out, and in that the form-wound coil is configured to fit into the laminated core in a direction parallel to this strip surface.

6. The method according to claim 4, wherein:
the metal sheet is produced from aluminum.

7. The method according to claim 1 wherein:
cutting out comprises water cutting or lasering.

8. The method according to claim 1 wherein:
the first and second slot-strip portions are separated into a plurality of parallel conducting portions, and the separating occurs before the angling away.

9. The method according to claim 8, further comprising:
introducing an electrical insulating material into interspaces between the parallel conducting portions of the separated slot-strip portions.

10. The method according to claim 8 wherein:
a first parallel conducting portion reaches from the first slot-strip portion to the second slot-strip portion and is arranged with the first slot-strip portion in a base region of the first slot and arranged with the second slot-strip portion in an opening region of the second slot.

11. The method according to claim 8 wherein:
the parallel conducting portions of a slot-strip portion have different cross sections.

12. The method according to claim 1 wherein:
in the connecting region between the coils the parallel conducting portions are separated non-electrically into a plurality of lines.

13. A form-wound coil, produced by a method according to claim 1.

14. A winding assembly with a plurality of form-wound coils according to claim 13.

15. The winding assembly according to claim 14, with a plurality of connecting portions, a connecting portion respectively connecting two of the form-wound coils and the connecting portion being produced by cutting out a flat conducting region from a metal sheet and angling away the flat conducting region in such a way that it is attached to two slot-strip portions for connecting to reach over a plurality of slots between the two form-wound coils.

16. The winding assembly according to claim 15, wherein the connecting portion corresponds in structure to the winding head portion.

17. A stator of a generator of a gearless wind turbine comprising:
a stator with a laminated stator core and a winding assembly according to claim 14 fitted into the laminated stator core.

18. The stator according to claim 17, wherein the laminated stator core has slots for receiving the slot-strip portions and the slots have a corresponding shape to the slot-strip portions.

19. A synchronous generator of a wind turbine with a stator according to claim 17.

20. A wind turbine with a synchronous generator according to claim 19.
